(19) United States
(12) Patent Application Publication
(10) Pub. No.: US 2008/0305366 A1
(43) Pub. Date: Dec. 11, 2008

(54) Magnetic recording tape configured for improved surface lubricity

(75) Inventors: Meng C. Hsieh, Woodbury, MN (US); Matthew N. Fraley, Minneapolis, MN (US); Timo E. Mahonen, Stacy, MN (US); Larold L. Olson, Lindstrom, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/811,159

(22) Filed: Jun. 8, 2007

(51) Int. Cl. G11B 5/65; B05D 5/12

(52) U.S. Cl. 428/835; 427/131; 428/834

(57) ABSTRACT

A magnetic recording tape configured for increased surface lubricity includes an elongated substrate and a magnetic side disposed on the substrate. The magnetic side includes a magnetic recording layer defining an exposed magnetic recording surface opposite the substrate, and a support layer deposited on the substrate between the substrate and the magnetic recording layer. The support layer includes nano-particles configured to release lubrication to the exposed magnetic recording surface. In this regard, the support layer configures the exposed magnetic recording surface to have a surface lubrication to total lubrication ratio (SL ratio) of greater than about 5%.

### THE FIELD

Aspects relate to magnetic recording tape configured to provide an exposed magnetic recording surface with improved lubricity.

### BACKGROUND

Magnetic recording tapes are widely used in audio, video, and computer data storage applications. Magnetic recording tapes generally employ thin substrates coated to include magnetic recording layers. The magnetic recording layers are coated onto one or both sides of a non-magnetic substrate (e.g., a plastic film). The coating is applied as a single layer directly onto the non-magnetic substrate, or in an alternative approach, a dual-layer construction is applied that includes a lower support layer coated on the substrate and a thin magnetic recording layer coated on the lower support layer. The two layers of the dual-layer construction may be formed simultaneously or sequentially.

The magnetic recording layer generally includes one or more magnetic metal particle powders or pigments dispersed in a binder system. The magnetic recording layer defines a recording surface that is configured to record and store information. The magnetic recording tape is wound/unwound through a tape drive to enable a read/write head of the drive to read data from, or write data to, the recording surface. Contact between the read/write head and the recording surface has a tendency to cause wear of the recording surface and the read/write head and leave deposits on the read/write head during read/write operations. With the above in mind, it is desired to provide the magnetic recording tape with an improved lubricated recording surface to increase the durability and life span of the tape.

### SUMMARY

One aspect provides a magnetic recording tape configured for increased surface lubricity. The magnetic recording tape includes an elongated substrate and a magnetic side disposed on the substrate. The magnetic side includes a magnetic recording layer defining an exposed magnetic recording surface opposite the substrate, and a support layer deposited on the substrate between the substrate and the magnetic recording layer. The support layer includes nano-particles configured to release lubrication to the exposed magnetic recording surface. In this regard, the support layer configures the exposed magnetic recording surface to have a surface lubrication to total lubrication ratio (SL ratio) of greater than about 5%.

Another aspect provides a magnetic recording tape configured for increased surface lubricity. The magnetic recording tape includes an elongated substrate and a magnetic side disposed on the substrate. The magnetic side includes a magnetic recording layer defining an exposed magnetic recording surface opposite the substrate, and a support layer deposited on the substrate between the substrate and the magnetic recording layer. The support layer includes carbon black particles having a surface area of between about 100-1000 m²/g that is configured to release lubrication to the exposed magnetic recording surface.

Another aspect provides a method of fabricating a magnetic recording tape providing improved surface lubrication. The method includes providing a substrate having a first side and a second side opposite the first side, and coating a magnetic recording layer defining an exposed magnetic recording surface opposite the substrate. The method additionally includes coating a support layer on the first side of the substrate that includes a lubricant and a dispersion of carbon black nano-particles having a surface topology that combine to configure the support layer to release lubrication to the exposed magnetic recording surface.

### BRIEF DESCRIPTION OF THE DRAWINGS

Embodiments are better understood with reference to the following drawings. The elements of the drawings are not necessarily to scale relative to each other. Like reference numerals designate corresponding similar parts.

FIG. 1 is a schematic cross-sectional view of a magnetic recording tape according to one embodiment;

FIG. 2 is a schematic cross-sectional view of a magnetic recording tape according to another embodiment;

FIG. 3 is a flow chart of a method of manufacturing the magnetic recording tapes of FIGS. 1 and 2 according to one embodiment;

FIG. 4 is a schematic side view of a calender stack employed to calender the magnetic recording tapes of FIGS. 1 and 2 according to one embodiment;

FIG. 5A is a graph of broadband signal-to-noise ratio for a magnetic recording tape according to one embodiment;

FIG. 5B is a graph of skirt signal-to-noise ratio for a magnetic recording tape according to one embodiment;

FIG. 6A is a pair of graphs representing the durability of a comparative magnetic recording tape in a five corner durability challenge according to one embodiment;

FIG. 6B is a pair of graphs representing the durability of a magnetic recording tape according to one embodiment relative to a five corner durability challenge;

FIG. 7 is a graph comparing lubricant present on surfaces of magnetic recording tapes; and

FIG. 8 is a graph comparing surface lubrication to total lubrication ratio (SL ratio) for magnetic recording tapes.

### DETAILED DESCRIPTION

In the following detailed description, specific embodiments are described and it is to be understood that other embodiments may be utilized, and structural or logical changes made, without departing from the scope of the disclosure. The following detailed description, therefore, describes certain embodiments and is not to be taken in a limiting sense. The scope of the disclosure is defined by the appended claims.

Magnetic recording tapes according to the embodiments described below include a magnetic recording layer defining an exposed magnetic recording surface opposite the substrate, and a support layer deposited on a substrate between the substrate and the magnetic recording layer. The support layer includes nano-particles that are configured to release lubrication to the exposed magnetic recording surface. Suitable nano-particles have a surface topology that presents a relatively low surface area of between about 100-1000 m²/g. Lubrication in the support layer is not completely retained by the pores of low surface area nano-particles, but is instead readily exuded by the nano-particles and made available at the exposed magnetic recording surface. The increased levels of lubricant exuded to the exposed magnetic recording surface of the magnetic recording tape increases the durability (and increases the life span) of the magnetic recording tape.

In this specification, nano-particles are defined to be particles having an average particle size of less than 100 nanometers (nm). Particles having a size of greater than 100 nm, including a dispersion of particles having an average particle size of greater than 100 nm, are not nano-particles.

In this specification, the terms “layer” and “coating” are used interchangeably to refer to a composition coated over another layer, coating, or substrate, or the like.

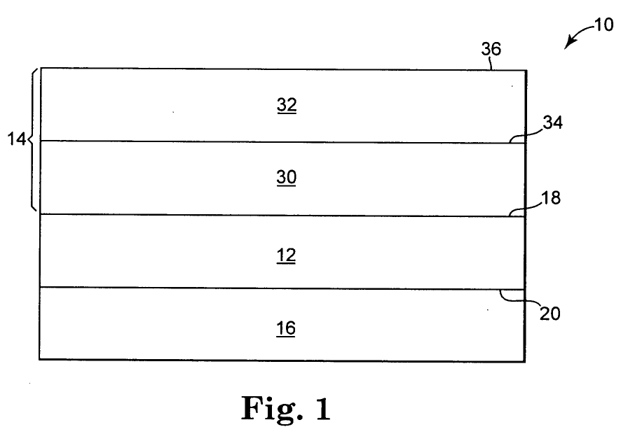

FIG. 1 is a schematic cross-sectional view of a magnetic recording tape 10 according to one embodiment. The magnetic recording tape 10 generally includes a substrate 12, a magnetic side 14 applied to a side of the substrate 12, and a backcoat 16 or backside 16 applied to an opposing side of the substrate 12. The substrate 12 defines a first or top surface 18 and a second or bottom surface 20 opposite top surface 18. The magnetic side 14 generally extends over and is bonded to top surface 18 of the substrate 12. The magnetic side 14 provides recordable material to the magnetic recording tape 10. The backside 16 generally provides support for the magnetic recording tape 10 and extends over and is bonded to the bottom surface 20 of the substrate 12.

Embodiments of magnetic recording tape 10 provide for increased mobility of lubricant from within magnetic side 14 to an exposed magnetic recording surface 36. The magnetic side 14 is fabricated to include nano-particles that have a relatively low surface area per mass. The small nano-particles with the relatively small surface area have a pore structure that preferentially exudes lubricant that migrates to the recording surface 36 of the tape 10. In other words, the low surface area per mass of the nano-particles configures the pores of the particles to release lubricant rather than “lock” the lubricant inside the particles. In this manner, the magnetic recording tape 10 has improved surface lubrication, such that the exposed magnetic recording surface is lubricated for a longer period of time, thereby increasing the durability and life span of the magnetic recording tape 10.

In one embodiment, the magnetic recording tape 10 is processed and configured for use in high density recording applications, such as for use with T10000, LTO3, LTO4, LTO5, Quantum S5, Quantum S6, 3592, or other suitably designed magnetic recording tape drives, while simultaneously providing a durable tape.

In one embodiment, the magnetic recording tape 10 is provided in a suitable LTO4 tape cartridge and is configured to conform to specifications of such cartridges employed in LTO4 drives. In one embodiment, the magnetic recording tape 10 has a width or form factor of 0.5 inch, is less than 10 microns thick, and the magnetic side 14 is configured to support at least a 30 MB/in² net uncompressed density utilizing a linear density of at least 200 kbpi.

### The Substrate

The substrate 12 includes conventional non-magnetic recording medium substrates/supports. In one embodiment, the substrate 12 is about 0.5 inches (1.27 cm) wide and has a thickness between 177 micro inches (4.5 μm) and 205 micro inches (5.21 μm). Suitable materials for substrate 12 include polyesters such as polyethylene terephthalate (PET), polyethylene naphthalate (PEN), blends or copolymers of polyethylene terephthalate and polyethylene naphthalate; polyolefins (e.g., polypropylene); cellulose derivatives; polyamides; and polyimides. In one example, the substrate 12 is fabricated of PEN in elongated tape form.

### The Magnetic Side: Support Layer and Magnetic Recording Layer

In one embodiment, the magnetic side 14 is formed of dual-layer construction including a support layer 30 and a magnetic recording layer 32 disposed on the support layer 30. The support layer 30 extends over the top surface 18 of the substrate 12, and in one embodiment the support layer 30 is directly bonded to the substrate 12. In other embodiments, the support layer 30 is bonded to the substrate via an intermediate layer (not shown), such as a primer layer. The support layer 30 defines a top surface 34 opposite the substrate 12.

The magnetic recording layer 32 extends over and is directly bonded to the top surface 34 of the support layer 30. The magnetic recording layer 32 defines the exposed magnetic recording surface 36 opposite the top surface 18 of the substrate 12 and opposite the top surface 34 of the support layer 30.

The Support Layer

In one embodiment, the support layer 30 includes at least a primary pigment material and conductive carbon black and is essentially non-magnetic. Accordingly, the primary pigment material includes a non-magnetic or soft magnetic powder. As used herein, the term “soft magnetic powder” refers to a magnetic powder having a coercivity of less than about 23.9 kA/m (300 Oe). By forming the support layer 30 to be essentially non-magnetic, the electromagnetic characteristics of the magnetic recording layer 32 are not substantially adversely affected by the support layer 30. However, to the extent that no substantial adverse effect is caused, the support layer 30 may contain a small amount of magnetic powder. In one embodiment, the primary pigment material includes non-magnetic particles, such as iron oxides, titanium dioxide, titanium monoxide, alumina, tin oxide, titanium carbide, silicon carbide, silicon dioxide, silicon nitride, boron nitride, etc., and, as described, soft magnetic particles. Optionally, these primary pigment materials are provided in a form coated with carbon, tin, or other electro-conductive material.

In one embodiment, the primary pigment material is formed of a non-magnetic α-iron oxide, which can be acidic or basic in nature. In one example, the non-magnetic α-iron oxides are substantially uniform in particle size, or are a metal that is dehydrated by heating, and annealed to reduce the number of pores. After annealing, the primary pigment material is ready for surface treatment, which is generally performed prior to mixing with other materials in the support layer 30 (e.g., the carbon black, etc.). In one embodiment, the particle length of the non-magnetic α-iron oxides, or other suitable primary pigment particles, is less than 150 nm, preferably less than 120 nm. Such α-iron oxides are commercially available from Dowa Mining Company Ltd. of Tokyo, Japan; Toda Kogyo Corp. of Hiroshima, Japan; and Sakai Chemical Industry Co. of Osaka, Japan.

In one example, the α-iron oxides or other primary pigment particles are included in the support layer 30 with a volume concentration of greater than about 35%, preferably greater than about 40%. Notably, component volume percents as used throughout this description were calculated by converting relative formulation material mass fractions by their pure component densities to obtain relative material volumes. The component volume percent was obtained by dividing these relative material volumes by the ratio of their sum to 100.

The conductive carbon black material provides a certain level of conductivity so as to prohibit the magnetic recording layer 32 from charging with static electricity and provides additional compressibility to the magnetic side 14. In one embodiment, the conductive carbon black material has an average particle size of between about 5-100 nm, preferably the average particle size is between about 5-50 nm, and more preferably the average particle size is between about 10-20 nm.

In one embodiment, a conductive carbon black identified as BP-880 available from Cabot Corporation, Boston, Mass. having a particle size of about 16 nm that is configured to provide a surface topology for the particle characterized by an average surface area of 220 m²/g is added in amounts of about 20 parts by weight to the formulation based on 100 parts by weight of the primary pigment material (e.g. α-iron oxide). The total amount of conductive carbon black and electro-conductive coating material in the support layer 30 is selected to be sufficient to contribute to providing a resistivity of the magnetic side 14 that is suitable for use on advance magnetoresistive (MR) heads. In one embodiment, the resistivity of the magnetic side 14 is less than about 1×10⁸ ohm/cm², preferably less than 5×10⁷ ohms/cm², more preferably less than 1×10⁷ ohms/cm².

In one embodiment, a dispersant is included in the support layer 30 formulation to disperse the carbon black particles. The dispersant additive is believed to improve overall dispersion rheology when coating the carbon black particles by effectively dispersing the carbon black to provide enhanced tape conductivity. Suitable dispersants include Disperbyk 161, Disperbyk 2000, or Disperbyk 2001 available from BykChemie (Altana company), Germany, added at about 2 parts per 100 parts of iron oxide.

In some embodiments, the support layer 30 includes an abrasive or head-cleaning agent (HCA), for example, aluminum oxide. Other abrasive grains, such as silica, ZrO₂, Cr₂O₃, etc., can be employed as the head-cleaning agent in the support layer 30 formulation. In one embodiment, the binder system of the support layer 30 further includes a head-cleaning agent binder used to disperse the selected head-cleaning agent, such as a polyurethane binder in conjunction with a pre-dispersed or paste head-cleaning agent. Alternatively, other head-cleaning agent binders compatible with the selected head-cleaning agent format (e.g., powder head-cleaning agent) may be utilized.

In one embodiment, the support layer 30 includes at least one binder resin, such as a thermoplastic resin, in conjunction with other resin components such as binders and surfactants used to disperse the head-cleaning agent, a surfactant (or wetting agent), and one or more hardeners. In one embodiment, the binder system of the support layer 30 includes a combination of a primary polyurethane resin and a vinyl chloride resin, a vinyl chloride-vinyl acetate copolymer, vinyl chloride-vinyl acetate-vinyl alcohol copolymer, vinyl chloride-vinyl acetate-maleic anhydride, or the like.

In one embodiment, the vinyl resin is a nonhalogenated vinyl copolymer. Useful vinyl copolymers include copolymers of monomers such as (meth)acrylonitrile; a nonhalogenated, hydroxyl functional vinyl monomer; a nonhalogenated vinyl monomer bearing a dispersing group, and one or more nonhalogenated nondispersing vinyl monomers. One example of a nonhalogenated vinyl copolymer is a copolymer of monomers comprising 5 to 40 parts by weight of methacrylonitrile, 30 to 80 parts by weight of one or more nonhalogenated, nondispersing, vinyl monomers, 5 to 30 parts by weight of a nonhalogenated hydroxyl functional, vinyl monomer, and 0.25 to 10 parts by weight of a nonhalogenated, vinyl monomer bearing a dispersing group. Other suitable binder resins are also acceptable.

Examples of useful polyurethanes include polyester-polyurethane, polyether-polyurethane, polycarbonate-polyurethane, polyester-polycarbonate-polyurethane, and polycaprolactone-polyurethane. Other resins such as bisphenol-A epoxide, styrene-acrylonitrile, and nitrocellulose are also acceptable for use in the support layer binder system.

In one embodiment, a primary polyurethane binder is incorporated into the support layer 30 in amounts of from about 5 to about 15 parts by weight based on 100 parts by weight of the primary pigment material. In one embodiment, the vinyl binder or vinyl chloride copolymer binder is incorporated into the support layer 30 in amounts from about 5 to about 20 parts by weight based on 100 parts by weight of the primary pigment material.

The binder system may include a surface treatment agent. In one embodiment, the surface treatment agent is a known surface treatment agent, such as phenylphosphinic acid (PPiA), 4-nitrobenzoic acid, and various other adducts of sulfuric, sulfonic, phosphoric, phosphonic, and carboxylic acids. In one embodiment, the binder system also contains a hardening agent or activator such as isocyanate, and/or polyisocyanate. In one example, the hardening agent is incorporated into the support layer 30 in amounts of from about 2 to about 5 parts by weight based on 100 parts by weight of the primary support layer pigment.

In one embodiment, the support layer 30 includes one or more lubricants such as a fatty acid and/or a fatty acid ester. The incorporated lubricant(s) exist throughout the magnetic side 14 and have mobility sufficient to reach the recording surface 36 of the magnetic recording layer 32 when the lubricant is released by the support layer 30. The lubricant(s) reduce magnetic tape friction, enabling the tape 10 to contact drive components with low drag, and protects the exposed magnetic recording surface 36 from wear. Thus, in one example, the lubricant(s) provided in both the support layer 30 and the magnetic recording layer 32 are selected and formulated in combination.

In one embodiment, the support layer 30 includes a stearic acid lubricant that is at least 90% pure as the fatty acid and butyl stearate as a fatty acid ester. Although technical grade acids and/or acid esters can also be employed for the lubricant component, incorporation of high purity lubricant materials generally ensures robust performance of the resultant coating. Alternatively, other acceptable fatty acids include myristic acid, palmitic acid, oleic acid, etc., and/or their mixtures. The support layer 30 can further include a fatty acid ester lubricant such as butyl stearate, isopropyl stearate, butyl oleate, butyl palmitate, butylmyristate, hexadecyl stearate, and oleyl oleate. The fatty acids and fatty acid esters may be employed singly or in combination. In one embodiment, the lubricant is incorporated into the support layer 30 in an amount of from about 1 to about 10 parts by weight, and preferably from about 1 to about 5 parts by weight, based on 100 parts by weight of the primary pigment material.

In one embodiment, the coating material of the support layer 30 is solvent-based. In one example, the solvents include cyclohexanone (CHO) with a concentration in the range of about 5% and about 50%, methyl ethyl ketone (MEK) with a concentration in the range of about 30% and about 90%, and toluene (Tol) with a concentration in the range of about 0% and about 40%. Alternatively, other solvents or solvent combinations including, for example, xylene, tetrahydrofuran, methyl isobutyl ketone, and methyl amyl ketone, are employed in formulating the coating material of the support layer 30.

The materials for the support layer 30 are mixed with the surface treated primary pigment, and the support layer 30 is coated onto the substrate 12. In one embodiment, the resultant support layer 30 has a thickness of between about 32 micro inches (0.81 μm) to about 50 micro inches (1.27 μm).

The Magnetic Recording Layer

In one embodiment, the magnetic recording layer 32 includes a dispersion of magnetic pigments, an abrasive or head-cleaning agent (HCA), a binder system, one or more lubricants, and/or a conventional surfactant or wetting agent. In one embodiment, the volume concentration of the magnetic pigments in the magnetic recording layer is greater than about 35%, preferably, greater than about 40%.

The magnetic pigments have a composition including, for example, metallic iron and/or alloys of iron with cobalt and/or nickel, and magnetic or non-magnetic oxides of iron, other elements, or mixtures thereof, which will hereinafter be referred to as metal particles. Alternatively, the metal particles can be composed of hexagonal ferrites such as barium ferrites.

In one embodiment, the metal particles have an average long axis length of less than about 60 nm, preferably less than about 50 nm. In one embodiment the average length of the metal particles utilized in the magnetic recording layer 32 are less than or equal to about 45 nm.

“Coercivity” and “magnetic coercivity” are synonymous and are abbreviated as Hc, and refer to the intensity of the magnetic field needed to reduce the magnetization of a ferromagnetic material (in this case the magnetic recording layer 32) to zero after the material has reached magnetic saturation. Use of metal particles with relatively high coercivity with a high volume concentration within the magnetic recording layer 32 causes the magnetic recording tape 10 to exhibit a significantly narrowed pulsewidth when measured by recording a signal on the magnetic recording tape 10 at a sufficiently low density such that the transitions are isolated from one another (i.e., they do not interact or interfere with one another). In one embodiment, the magnetic pigment utilized in the magnetic recording medium has a coercivity greater than about 183 kA/m (2300 Oe).

The magnetic pigments may contain various additives, such as semi-metal or non-metal elements and their salts or oxides, such as Al, Co, Y, Ca, Mg, Mn, Na, and other suitable additives. The selected magnetic pigment may be treated with various auxiliary agents before it is dispersed in the binder system.

The head-cleaning agent may be added to the magnetic recording layer 32 dispersion separately, or may be dispersed within a binder system prior to addition to the magnetic recording layer 32 dispersion. In one embodiment, the head-cleaning agent is aluminum oxide. Other abrasive grains, such as silica, ZrO₂, CrO₃, etc., can also be employed either alone or in mixtures with aluminum oxide or each other to form the head-cleaning agent.

In one embodiment, the head-cleaning agent is added in a manner configured to increase the surface presentation of the head-cleaning agent throughout the life of the magnetic recording tape 10. However, a simple increase in the amount of head-cleaning agent included in the magnetic recording layer 32 dispersion has been found to decrease the magnetic particle concentration in the magnetic recording layer 32, subsequently decreasing the magnetic recording properties of the magnetic recording tape 10, which, for most examples, is generally undesirable in high density recording applications. In one embodiment, the mean particle size of the head-cleaning agent is not greater than 90 nm, and the volume concentration of the head-cleaning agent is provided at a level of at least 6.5%, more preferably, of at least 7%.

Providing a head-cleaning agent with a decreased mean particle size and increased volume concentration as described above has proven to maintain abrasivity of the magnetic recording tape 10 over the lifespan of the magnetic recording tape 10 as opposed to other media in which larger head-cleaning agent particles are used.

The binder system of the magnetic recording layer 32 includes at least one binder resin, such as a thermoplastic resin, in conjunction with other resin components, such as binders and surfactants used to disperse the head-cleaning agent, a surfactant or wetting agent, and one or more hardeners. In one embodiment, the binder system of the magnetic recording layer 32 includes a combination of a primary polyurethane resin and a vinyl resin. Examples of polyurethanes include polyester-polyurethane, polyether-polyurethane, polycarbonate-polyurethane, polyester-polycarbonate-polyurethane, and polycaprolactone-polyurethane. The vinyl resin is frequently a vinyl chloride resin, a vinyl chloride-vinyl acetate copolymer, vinyl chloride-vinyl acetate-vinyl alcohol copolymer, vinyl chloride-vinyl acetate-maleic anhydride and the like. Resins such as bis-phenyl-A epoxide, styrene-acrylonitrile, and nitrocellulose may also be acceptable in certain magnetic recording medium formulations.

In an alternate embodiment, the vinyl resin is a non-halogenated vinyl copolymer. Useful vinyl copolymers include copolymers of monomers such as (meth)acrylonitrile; a nonhalogenated, hydroxyl functional vinyl monomer; a nonhalogenated vinyl monomer bearing a dispersing group, and one or more nonhalogenated nondispersing vinyl monomers. In one embodiment, the nonhalogenated vinyl copolymer is a copolymer of monomers comprising 5 to 40 parts by weight of methacrylonitrile, 30 to 80 parts by weight of one or more nonhalogenated, nondispersing, vinyl monomers, 5 to 30 parts by weight of a nonhalogenated hydroxyl function, vinyl monomer, and 0.25 to 10 parts by weight of a nonhalogenated vinyl monomer bearing a dispersing group.

In one embodiment, the primary polyurethane binder is incorporated into the magnetic recording layer 32 in an amount of about 4 to about 10 parts by weight based on 100 parts by weight of the magnetic pigment, and the vinyl or vinyl chloride binder is incorporated in an amount of from about 8 to about 20 parts by weight based on 100 parts by weight of the magnetic pigment.

In one example, the binder system further includes a head-cleaning agent binder used to disperse the selected head-cleaning agent material, such as a polyurethane binder in conjunction with a pre-dispersed or paste head-cleaning agent. Use of other head-cleaning agent binders compatible with the format of the selected head-cleaning agent (e.g., powder head-cleaning agent) is also contemplated.

In one embodiment, the magnetic recording layer 32 includes one or more lubricants such as a fatty acid and/or a fatty acid ester. The incorporated lubricant(s) exist throughout the magnetic side 14 including at the recording surface 36 of the magnetic recording layer 32. In general, the lubricant(s) reduce friction to maintain smooth contact with low drag and at least partially protects the recording surface 36 from wear. During use, the lubricant is depleted from the recording surface 36. To this end, the lubricant(s) provided in the support layer 30 are selected, configured, and formulated to replenish lubricant at the recording surface 36.

Suitable lubricants include fatty acid lubricants, stearic acid that is at least about 90% pure, and/or butyl palmitate, myristic acid, palmitic acid, oleic acid, etc., and their mixtures. The upper layer formulation can further include a fatty acid ester such as butyl stearate, isopropyl stearate, butyl oleate, butyl palmitate, butylmyristate, hexadecyl stearate, and oleyl oleate. The fatty acids and fatty acid esters may be employed singly or in combination. In one embodiment, lubricants are incorporated into the magnetic recording layer 32 in an amount from about 1 to about 10 parts by weight based on 100 parts by weight of the magnetic pigment.

A surfactant or wetting agent may be added separately to the magnetic recording layer dispersion including one or more of the above-identified components, or added to the binder system prior to being added to the magnetic recording layer dispersion. In one embodiment, known surfactants, such as phenylphosphinic acid (PPiA), 4-nitrobenzoic acid, and various other adducts of sulfuric, sulfonic, phosphoric, phosphonic, and carboxylic acids are utilized. In one embodiment, the binder system contains a hardening agent or activator such as isocyanate, and/or polyisocyanate. In one example, the hardener component is incorporated into the magnetic recording layer 32 in an amount of from about 2 to about 6 parts by weight based on 100 parts by weight of the magnetic pigment.

The materials for the magnetic recording layer 32 are mixed together to form a magnetic recording layer dispersion that is coated onto the upper surface 34 of the support layer 30 to form the magnetic recording layer 32. In one embodiment, solvents are added to the magnetic recording layer dispersion prior to coating the support layer 30 with the magnetic recording layer 32. Suitable solvents include cyclohexanone (CHO) with a concentration in the range of about 5% about 50%, methyl ethyl ketone (MEK) with a concentration in the range of about 30% to about 90%, or toluene (Tol) with a concentration in the range of about 0% and about 40%. Other solvents or solvent combinations including, for example, xylene, tetrahydrofuran, methyl isobutyl ketone, and methyl amyl ketone are also acceptable.

In one embodiment, the magnetic recording layer 32 has a final thickness from about 2 micro inches (0.05 μm) to about 5 micro inches (0.125 μm), more preferably, from about 3 micro inches (0.75 μm) to about 5 micro inches (0.125 μm). In one embodiment, the magnetic recording layer 32 is formed to have a remanent magnetization-thickness product (Mr*t) of between about 2.0 to 2.8 memu/cm², preferably between about 2.3 to 2.5 memu/cm². In one embodiment, the magnetic recording layer 32 is formed to have a Mr*t of between about 2.4 to 3.0 memu/cm², preferably between about 2.6 to 2.8 memu/cm². The term “remanent magnetization-thickness product” refers to the product of the remanent magnetization after saturation in a strong magnetic field (796 kA/m, for example) multiplied by the thickness of the magnetic coating.

### The Backside

In one embodiment, the backside 16 includes a soft (i.e., Moh's hardness<5) non-magnetic particle material such as carbon black or silicon dioxide particles. In one embodiment, the backside 16 includes a carbon black component in combination with appropriate binder resins.

As is known in the art, pigments of the backside 16 dispersed as inks with appropriate binders, surfactant, ancillary particles, and solvents are typically purchased from a designated supplier. In a preferred embodiment, the backside binder includes at least one of the following: a polyurethane polymer, a phenoxy resin, or nitrocellulose added in an amount appropriate to modify coating stiffness as desired. The backside 16 is coated onto the bottom surface 20 of the substrate 12 to increase the durability of the magnetic recording tape 10. In one embodiment, the backside is coated to have a thickness between about 23 micro inches (0.58 μm) and about 28 micro inches (0.71 μm).

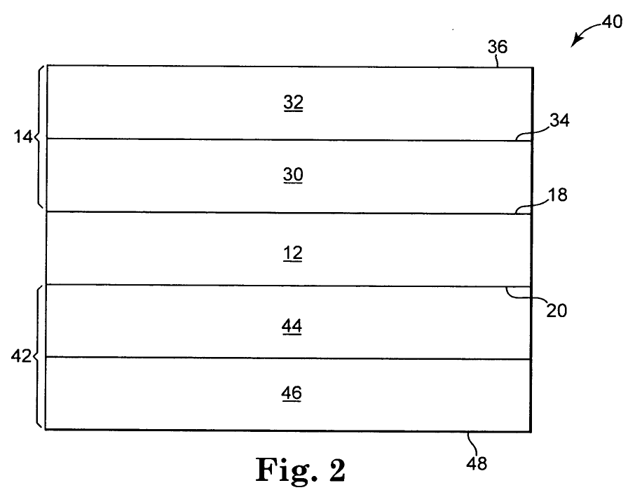

FIG. 2 is a schematic cross-sectional view of another magnetic recording tape 40 according to one embodiment in which backside 16 as described above is replaced with a second magnetic side 42 to form magnetic recording tape 40. Tape 40, except for those differences specifically enumerated herein, is substantially similar to the magnetic recording tape 10. The second magnetic side 42 is similar to the first magnetic side 14, but is coated over the bottom surface 20 of the substrate 12. A second support layer 44, which is similar to the support layer 30, extends over the bottom surface 20 of the substrate 12. A second magnetic recording layer 46, which is similar to the magnetic recording layer 32, extends over the second support layer 44 opposite the substrate 12. As such, the second magnetic recording layer 46 defines a second exposed magnetic recording surface 48 opposite the first exposed magnetic recording surface 36. Although the remainder of this description refers to magnetic recording tape 10 with a single magnetic side 14, it should be understood that such description also translates to use with the dual-magnetic side recording tape 40.

### One Suitable Manufacturing Process

In one embodiment, each of the components of the support layer 30 are combined in a manner described above to form a coating to be applied to the substrate 12, and each of the magnetic recording layer 32 and the backside 16 are mixed to form the respective coating mixtures that are subsequently coated on the upper surface 34 of the support layer 30 and the bottom surface 20 of the substrate 12.

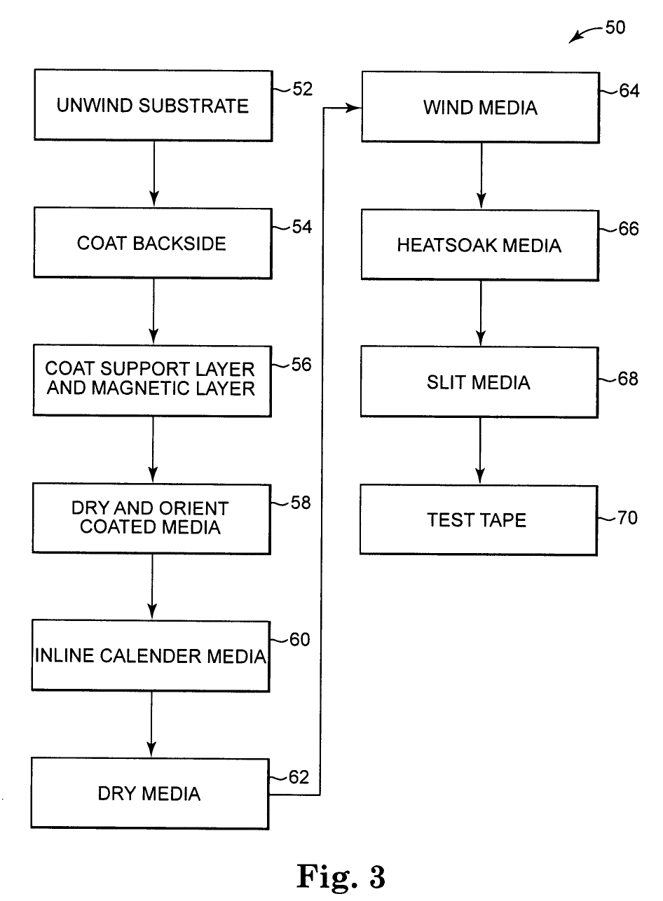

FIG. 3 is a flow chart generally illustrating one embodiment of a method 50 for manufacturing the magnetic recording tape 10 of FIG. 1. In one embodiment, process 50 for manufacturing of magnetic recording tape 10 includes an inline portion and one or more off-line portions. An inline portion includes unwinding a sheet form of the substrate 12 or other material from a spool or supply roll at 52. At 54, the substrate 12 is coated with the backside 16 material on the lower surface 20 of substrate 12. At 56, the magnetic side 14 is applied to the substrate 12. For the dual-layer magnetic side 14, the support layer 30 is first applied directly to the substrate 12 and the magnetic recording layer 32 is then coated over the support layer 30 in a wet-on-wet process. Alternatively, the magnetic side 14 can be applied to the substrate 12 prior to application of the backside 16 to the substrate 12. In one embodiment, the support layer 30, magnetic layer 32, and backside 16 are applied to substrate 12 or each other using wet-on-wet, wet-on-dry, dual-slot, sequential die, or another coating process.

A sheet that will eventually be cut into a plurality of magnetic recording tapes 10 is provided with the substrate, the magnetic side 14 opposite the backside 16 to have a similar cross-section as illustrated in FIG. 1 for the magnetic recording tape 10. Accordingly, manufacturing steps performed on the sheet are effectively being performed on a plurality of magnetic recording tapes 10.

The sheet is magnetically orientated and dried at 58. Specifically, in one embodiment the magnetic side 14 of the sheet is orientated by advancing the sheet through one or more magnetic fields to generally align the magnetic orientation of the metal particles of the magnetic recording layer 32 to have an orientation ratio greater than about 2.2, preferably greater than about 2.4. This level of orientation of the magnetic particles generally increases the recording characteristics of the resultant magnetic recording tapes 10. In one example, each magnetic field is formed by electric coils and/or permanent magnets.

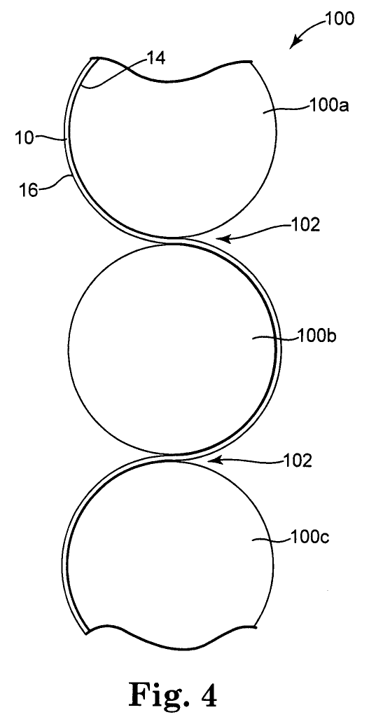

FIG. 4 is a schematic side view of a calender stack 100 employed to calender the magnetic recording tapes 10. With reference to both FIGS. 3 and 4, following orientation and drying, the sheet is inline calendared at 60. According to one embodiment, inline calendering at 60 includes steel-on-steel (SOS) inline calendering of the sheet. SOS inline calendering uses two or more inline, steel rollers 100 which interact with each other to form a nip station 102 between each adjacent roller 100. The sheet (e.g., sheet 10′) is advanced over the rotating rollers 100, and the rollers 100 are applied to the sheet 10′ to compress the sheet 10′. At each nip station 102, a steel roller 100a contacts or otherwise is applied to the magnetic side 14 of the sheet 10′ and the second steel roller 10b, which is adjacent the first steel roller 100a, contacts or otherwise is applied to an outer surface of the backside 16 of the sheet 10′ opposite the substrate 12. As such, the sheet 10′ is compressed between the adjacent rollers 100a and 100b.

In one embodiment, a nip pressure per linear inch of the sheet 10′ is measured at each nip station 102 is less than about 2000 lb/in (350.2 N/mm) at each nip station 102. In one embodiment, calendering further includes heating the rollers 100 to facilitate compression of the sheet 10′. Each of rollers 100 is heated to a desired temperature based on which side 14 or 16 of the sheet 10′ the particular roller 100 will contact. For example, referring to FIG. 4, a first roller 100a is configured to contact the magnetic side 14 of sheet 10′, a second roller 100b, which is adjacent the first roller 100a, is configured to contact the backside 16, and a third roller 100c, which is adjacent the second roller 100b opposite the first roller 100a, is configured to contact the magnetic side 14. With this in mind, the first and third rollers 100a and 100c are considered magnetic side rollers, and the second roller 100b is considered a backside roller.

In one embodiment, the magnetic side rollers 100a and 100c are heated to a different temperature than the backside roller 100b. In one embodiment, the magnetic side rollers 100a and 100c are heated to a temperature of less than or equal to 175° F. (79.4° C.), more preferably, of less than or equal to 150° F. (65.6° C.). In one embodiment, the backside roller 100b is heated to a temperature of less than or equal to 160° F. (71.1° C.), more preferably, of less than or equal to 150° F. (65.6° C.).

Embodiments provide inline calendering that includes “compliant-on-steel” (COS) calendering in which both steel and compliant rolls are used. After inline calendering, the sheet 10′ is further dried at 62. The dried magnetic recording sheet 10′ is subsequently wound onto a take-up roll at 64. At 66, the wound, sheet 10′ is heat soaked at a temperature of about 122° F. (50° C.) or other suitable temperature.

In one embodiment, the magnetic recording tape 10 is heat soaked at 66 for about 60 hours or for any other suitable time period.

In one embodiment, the sheet 10′ is suited for use as a magnetic tape in a LTO4 tape cartridge and is off-line calendered after heatsoaking at 66 and prior to slitting at 68. Other magnetic recording tapes are not off-line calendered. In this regard, depending upon the use to which the magnetic tape is ultimately directed, off-line calendaring is optional.

Subsequently, the sheet 10′ is cut into elongated strips to form the individual magnetic recording tapes 10 at 68. The magnetic recording tapes 10 are tested and/or packaged within cartridge for sale and use at 70.

A magnetic recording medium according to the embodiments of the present invention provides for durable medium for use in high density applications such as for use with T10000, LTO3, LTO4, LTO5, and other high density drives. The magnetic recording mediums described above provide for increased surface lubricant leading to better interfacial lubrication of the magnetic recording medium and components along a tape path that interact with the magnetic recording tape (i.e., interaction between the magnetic recording tape and the magnetic head of an associated drive) while still supporting high net uncompressed recording densities of not less than 30 MB/in² utilizing linear densities of at least 200 kbpi. Increased lubrication leads to increased durability and life span of the magnetic recording medium.

### EXAMPLES

An example of a magnetic recording tape formed in accordance with the above-described embodiments is described in detail below and compared to a comparative example of a prior art magnetic recording tape.

### Example 1

Example 1 is a LTO4-compatible magnetic recording tape formed with a PEN substrate, a magnetic side, and a backside. The PEN substrate was formed to have a thickness of between 177 and 205 micro inches, and the magnetic side was formed of dual-layer construction to include a support layer and a magnetic layer where the magnetic recording layer was formed to have a Mr*t of about 2.4 memu/cm². One exemplary embodiment of the support layer 30 is identified as a BP-880 support layer including 3% stearic acid, a primary pigment, a surfactant, BP-880 carbon black, a binder, lubricants, and an activator mixed in the following amounts expressed in parts by weight per 100 parts of the primary pigment:
A primary pigment including 100 parts α-iron oxide identified as DB-65 available from Toda Kogyo Corp. of Hiroshima, Japan.
A surfactant including 3 parts phenylphosphinic acid.
A carbon black including 20 parts of BP-880 carbon available from Cabot Corporation USA. BP-880 has a particle size of about 16 nm with a surface area of about 220 m²/g.
A binder including 9.14 parts of UR4125 primary polyurethane resin available from Toyobo of Japan, and 13.43 parts of MR-104 vinyl chloride copolymer available from Nippon Zeon Co. Ltd. of Tokyo, Japan.
Lubricants including 2 parts butyl stearate and 3 parts stearic acid.
An activator including 4.3 parts of a 55 weight percent solution of polyisocyanate in methylethylketone identified as L-55 and available from Bayer Corporation of Pittsburgh, Pa.

The magnetic layer is coated over the support layer in a wet-on-wet process. The magnetic layer includes a primary pigment, a surfactant, carbon black, a head-cleaning agent, binders, lubricants, and an activator mixed in the following amounts expressed in parts by weight per 100 parts of the primary pigment:
A primary pigment including 100 parts of NF-406 ferromagnetic metal particles available from Toda Kogyo Corp of Hiroshima, Japan.
A surfactant including 3.0 parts phenylphosphinic acid.
A carbon black including 0.5 parts of Sevacarb MT rubber carbon black available from Columbian Chemical of Marietta, Ga., and 0.5 parts of Raven 410 carbon black having a mean particle size of 101 nm available from Columbian Chemical.
A head-cleaning agent including 11.9 parts HIT70A aluminum oxide available from Sumitomo Chemical Co.
Binders including 4.36 parts of UR4125 primary polyurethane resin available from Toyobo, and 10.24 parts of MR-104 vinyl chloride copolymer available from Nippon Zeon Co. Ltd.
Lubricants including 1 part butyl palmitate and 1 part stearic acid.

An activator including 3.06 parts of a 55 weight percent solution of polyisocyanate in methylethylketone (e.g., Mondur.TRM. CB55N available from Bayer Corporation).

The support layer is coated over the substrate at a thickness of 32 micro inches (0.81 μm) to 50 micro inches (1.27 μm), and the magnetic layer is wet-on-wet coated over the support layer with a thickness of 3 micro inches (0.075 μm) to 5 micro inches (0.125 μm).

### Comparative Example C1

Comparative Example C1 is a conventional LTO4-compatible magnetic recording tape formed of a PEN substrate and including a magnetic side and a backside. The PEN substrate was formed to have a thickness of between 177 and 205 micro inches, and the magnetic side was formed of a dual-layer construction to include a support layer and a magnetic layer. The support layer of Comparative Example C1 is identified as an EC600 support layer including EC600 carbon black having 3% stearic acid and includes a primary pigment, a surfactant, carbon black, a head-cleaning agent, binders, lubricants, and an activator mixed in the following amounts expressed in parts by weight per 100 parts of the primary pigment:
The primary pigment includes 100 parts α-iron oxide (e.g., DB-65 available from Toda Kogyo Corp. of Hiroshima, Japan);
The surfactant includes 1.5 parts phenylphosphinic acid;
The carbon black includes 5.5 parts of Ketjenblack EC-600JD (available from Akzo Nobel of the Netherlands);
The head-cleaning agent includes 5 parts aluminum oxide (e.g., HIT60A available from Sumitomo Chemical Co. of Japan);
The binders include 8.31 parts of a primary polyurethane resin (e.g., UR4125 available from Toyobo of Japan) and 11.07 parts of a vinyl chloride copolymer (e.g., MR-104 available from Nippon Zeon Co. Ltd. of Tokyo, Japan);
The lubricants include 2 parts butyl stearate and 3 parts stearic acid; and

The activator includes 3.6 parts of a 55 weight percent solution of polyisocyanate in methylethylketone (e.g., Mondur TRM CB55N available from Bayer Corporation of Pittsburgh, Pa.).

### Test Results

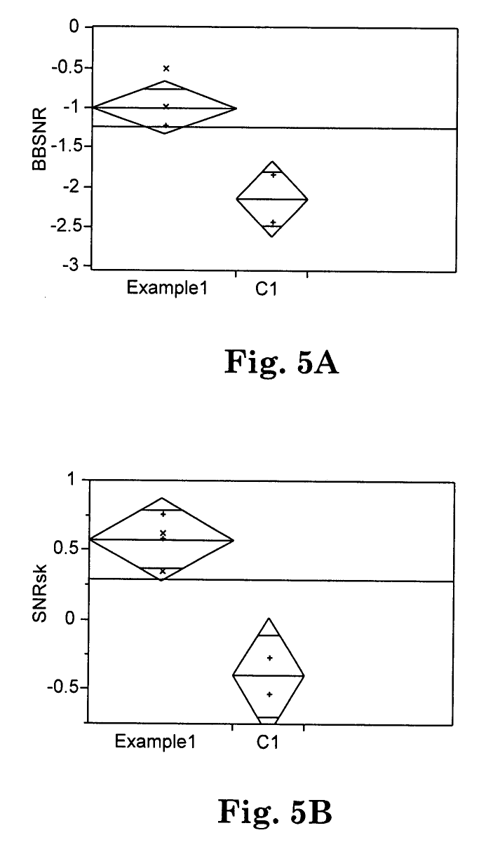

FIG. 5A is a graph comparing broadband signal-to-noise ratio for Example 1 and Comparative Example C1. Broadband signal-to-noise ratio (BBSNR) is the ratio of the average signal power to the average integrated broadband noise power of a magnetic recording medium clearly written at the test recording density. The noise power is integrated from about 1 MHz to 20 Mhz. One example method of measuring BBSNR is described in ECMA International Standard 319. The BBSNR of the tape 10 of Example 1 outperforms the tape of Comparative Example C1 by a difference of about 1 decibel.

FIG. 5B is a graph comparing skirt signal-to-noise ratio for Example 1 and Comparative Example C1. Skirt Signal-to-Noise Ratio (SkSNR) is a measure of the modulation noise-for-noise sources at frequencies close to the fundamental write frequency of the magnetic recording medium. SkSNR is typically measured by comparing the peak signal power and the integrated noise power within 1 megahertz of the fundamental write frequency of the magnetic recording medium. One example method of measuring SkSNR is described in ECMA International Standard 319. Example 1 provides superior performance in comparison to Comparative Example C1 as evidenced by FIG. 5B in which the SkSNR of Example 1 is higher than the SkSNR of Comparative Example C1 by about 1 decibel.

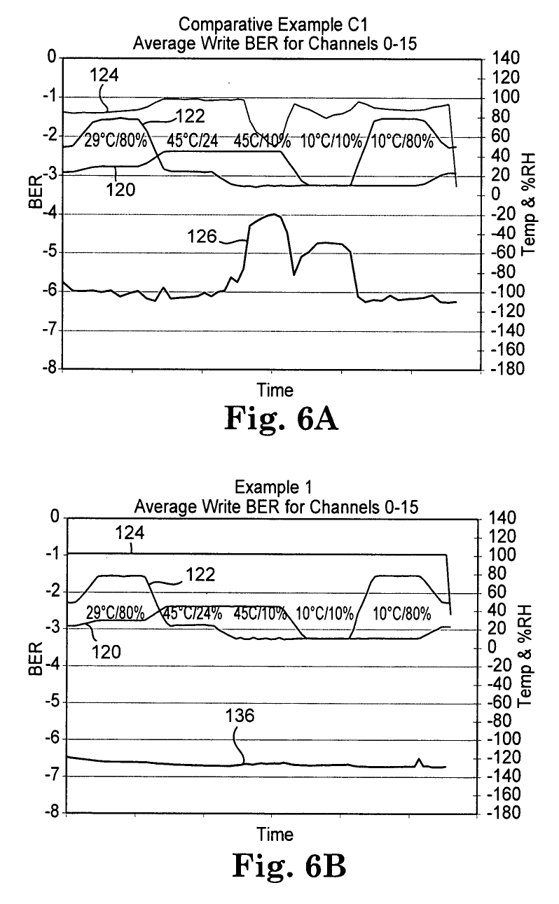

FIG. 6A illustrates the Average Write BER over multiple different channels for Comparative Example C1, and FIG. 6B illustrates the Average Write BER over multiple channels for Example 1. FIGS. 6A and 6B represent a comparison of the durability performance for the conventional tape of Comparative Example 1 and the tape of Example 1.

The durability performance is evaluated in a Five Corner durability challenge that includes cycling the magnetic recording tape in a tape drive (e.g., back and forth) while changing the temperature and relative humidity conditions to which the tape is exposed.

The challenge conditions for the durability performance of the Five Corner durability challenge of FIG. 6A include a temperature curve 120, a humidity curve 122, and a capacity curve 126 that represent:
Equilibrating the tape at 3.5 hours at 23° C./50% RH
Ramping the temperature and humidity to 29° C./80% RH over about 8 hours
Maintaining for about 16 hours the temperature and humidity at 29° C./80% RH
Changing the conditions to 45° C./24% RH over about 8 hours
Maintaining for about 16 hours at temperature and humidity conditions of about 45° C./24% RH Changing the conditions to 45° C./10% RH over about 8 hours
Maintaining the temperature and humidity for about 16 hours at 45° C./10% RH
Changing the conditions to 10° C./10% RH over about 8 hours Maintaining the temperature condition for about 16 hours at 10° C./10% RH
Changing the temperature conditions to 10° C./80% RH over about 8 hours
Maintaining the conditions for about 16 hours at 10° C./80% RH
Changing the conditions to 23° C./50% RH over about 8 hours
Maintaining the conditions for 3.5 hours at 23° C./50% RH.

Thus, the Five Corner test cycles the tape while increasing temperature and decreasing humidity, decreasing temperature and maintaining humidity, increasing humidity and maintaining temperature, increasing temperature and decreasing humidity, while an average BER is recorded and plotted as an average BER curve 126.

With this in mind, FIG. 6A illustrates that the average BER of the Comparative Example C1 grows in at least two environmental conditions (45° C./10% RH and 10° C./10% RH). The BER of the magnetic tape of Comparative Example C1 is thus undesirably high for these two environmental conditions.

In contrast, the average BER curve 136 of Example 1 is shown in FIG. 6B. The average BER curve 136 was recorded for the same challenge conditions (FIG. 6A) including the temperature curve 120 and the humidity curve 122, resulting in a substantially constant capacity curve 124. The BP-880 formulation of Example 1 improves the durability of the tape as illustrated by the absence of BER growth in the average BER curve 136. Example 1 has a lower BER over the entire range of the Five Corner challenge, and thus has superior durability over Comparative Example C1 as evidenced by having an absence of undesirable growth in BER. The magnetic recording tape of Example 1 is more durable in Five Corner testing, has improved parametrics, and has lower defects than the media of Comparative Example C1.

During use, and over the course of more than one-hundred head-tape cycles, Example 1, including the BP-880 formulation will exhibit growth in the average BER after about 120 cycles when challenged at 23° C./10% RH. In one embodiment, the BP-880 formulation of Example 1 is modified to include a 1% CFCOOH fluorinated lubricant that does not exhibit growth in the average BER until after about 200 cycles when challenged at 23° C./10% RH. Thus, the tape of Example 1 having improved durability over the conventional tape of Comparative Example C1 can be further improved to provide an even longer recording life when modified to include a fluorinated lubricant.

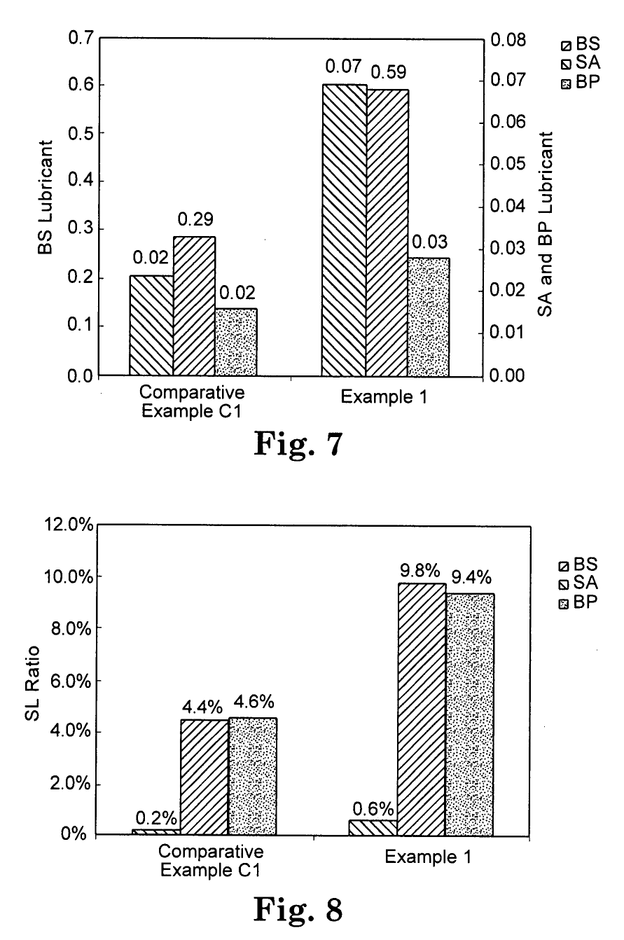

FIG. 7 is a graph of lubricant present on the surface of the magnetic recording tape for Example 1 and Comparative Example C1. Three lubricants were evaluated in the magnetic recording tapes including butylstearate (BS) lubricant, stearic acid (SA) lubricant, and butyl palmate (BP) lubricant.

In general, lubricant is added to all magnetic recording tapes. The lubricant can be added to one or more layers. However, it is the lubricant that is present on the exposed surfaces of the tape that contributes to reducing friction during use and increasing the durability of the tape. The total lubricant, or the total amount of lubricant that is available to be drawn to the exposed recording surface, can be quantified by extracting the lubricant from the tape using a solvent (such as hexane). This solvent extraction approach quantifies the total lubricant in the tape, but does not indicate how much lubricant is present at the surface of the tape.

The lubricant at the exposed magnetic recording surface was evaluated in a surface wipe method in which the lubricant interior to the recording tape (i.e., within the support layer) was not extracted. The wipe method removes the lubricant at the exposed magnetic recording surface by passing a 1-inch by 1-inch toluene saturated wipe, such as a commercially available paper towel or other wipe that is not contaminated with organic material can affect readings of a gas chromatography system, across a 48 foot length of a recording surface of the magnetic recording tape. The wipe is first saturated in toluene. The toluene saturated wipe is placed on top of the magnetic recording tape, which is positioned to be supported by a metal bar, and a 500 gram weight is lowered onto the wipe. While the 500 gram weight applies pressure to the wipe, the magnetic recording tape is pulled quickly across the metal bar for about 36 inches to wipe the surface of the magnetic recording tape. The used wipe (presumed to include the lubricant removed from the exposed surface of the tape) is placed in a vial and the “wiping” described above is repeated 16 times placing each of the 16 wipes into the same vial.

Subsequently, 20 ml of solvent is placed in the vial, and the vial is placed in a shaker with a Pierce heating block set for 80° C. for 1.5 hours. The vial is removed from the heater and is cooled at room temperature for about 0.5 hour. The sample is then analyzed using a gas chromatography system to quantify the amount of lubricant present at (i.e., removed) from the exposed magnetic recording surface. A surface lubrication (SL) SL ratio is calculated that represents the ratio (as a percent) of lubricant wiped from the magnetic recording surface of the tape in proportion to the total lubricant extracted from the magnetic recording tape (the SL ratio is calibrated to take into account that more tape area (e.g., length) is “wiped” than is exposed to solvent extraction).

FIG. 7 illustrates that Comparative Example C1 included about 0.02 SA lubricant, 0.29 BS lubricant, and 0.02 BP lubricant present at the exposed magnetic recording surface of the tape. In contrast, Example 1 was evaluated to have significantly more lubricant present at the exposed magnetic recording surface of the tape, including about 0.07 SA lubricant, 0.59 BS lubricant, and 0.03 BP lubricant present at the exposed magnetic recording surface of the tape. In general, Example 1 has about twice the lubricant at the surface as compared to Comparative Example C1, and there is a higher percent of ester lubricants present on the surface of Example 1 as compared to Comparative Example C1.

FIG. 8 is a graph of surface lubrication to total lubrication ratio (SL ratio) according one embodiment. As described above, the SL ratio represents the ratio (as a percent) of lubricant located at the magnetic recording surface of the tape in proportion to the total lubricant in the magnetic recording tape. In general, Example 1 includes a higher percent of ester lubricants present on the magnetic recording surface 36 compared to Comparative Example C1 when the amount of lubricant present on the surface is divided by the total extractable lubricants. Relative to Example 1, the SL ratio for BS lubricant is about 9.8%, and the SL ratio of BP lubricant is about 9.4%. In comparison, the Comparative Example as an SL ratio for BS lubricant of about 4.4%, and an SL ratio for BP lubricant of about 4.6%. Consequently, Example 1 has about twice the amount of surface lubricant when compared to Comparative Example C1, which configures the magnetic recording tape of Example 1 to have improved durability and longer service life. In one embodiment, the support layer 30 configures the exposed magnetic recording surface 36 to have a surface lubrication to total lubrication ratio (SL ratio) of between about 5-20%.

The results of the wiped test method represented in FIGS. 7 and 8 above provide data for comparison of the amount of lubricant present at the recording surface of the magnetic recording tape. This method has been found to more accurately represent the amount of surface lubricant on the magnetic recording tape than other known methods of dissolving all of the lubricant in the magnetic recording tape (such as a hexane extraction test). The hexane extraction method in which the tape is immersed in solvent provides a measure of total lubricant throughout the entire magnetic recording tape rather than just the lubricant desirably present at the surface. The wipe method of evaluating lubricant at the exposed magnetic surface more effectively quantifies tape performance, since during use of the magnetic recording tape, the lubrication at the recording surface provides for tape durability and tape service life.

While not intending to be bound by this theory, it is believed that the BP-880 particles having a particle size of between about 5-80 nm and a surface area of between about 100-1000 m² μg configure the support layer 30 to surprisingly and desirably exude lubricant contained within the support layer formulation to the exposed magnetic recording surface 36 of the tape 10 (FIG. 1). Notably, the EC600 carbon black particles of the Comparative Example C1 have more surface area, and the EC600 particles appear to retain the lubricant rather than exude the lubricant to the exposed magnetic recording surface. Thus, the Comparative Example 1 has less favorable BBSNR and SNRsk and higher average write BER than the BP-880 formula of Example 1.

Magnetic tape fabricated as described in Example 1 has improved surface lubricity compared to Comparative Example C1. The amount of lubricant at the surface is lubricant available to ease interaction between the magnetic recording tape and the tape drive or cartridge components. Increased surface lubricant provides for a decrease in interfacial stresses relative to the magnetic recording tape, and thereby, provides increased durability of the magnetic recording tape.

Although specific embodiments have been described herein, it will be appreciated by those of ordinary skill in the art that a wide variety of alternate and/or equivalent implementations calculated to achieve the same purposes may be substituted for the specific embodiments described without departing from the scope of the invention. This application is intended to cover any adaptations or variations of the specific embodiments discussed herein. Therefore, it is manifestly intended that this invention be limited only by the claims and their equivalents.

What is claimed is:

1. A magnetic recording tape configured for increased surface lubricity, the magnetic recording tape comprising:
an elongated substrate; and
a magnetic side disposed on the substrate and including:
a magnetic recording layer defining an exposed magnetic recording surface opposite the substrate,
a support layer deposited on the substrate between the substrate and the magnetic recording layer, the support layer including nano-particles configured to release lubrication to the exposed magnetic recording surface;
wherein the support layer configures the exposed magnetic recording surface to have a surface lubrication to total lubrication ratio (SL ratio) of greater than about 5%.

2. The magnetic recording tape of claim 1, wherein the support layer comprises a resin composition coated onto the substrate, the resin composition comprising carbon black nano-particles and at least one lubricant selected from the group consisting of stearic acid, butyl stearate, isopropyl stearate, butyl oleate, butyl palmitate, butylmyristate, hexadecyl stearate, and oleyl oleate.

3. The magnetic recording tape of claim 1, wherein the support layer configures the exposed magnetic recording surface to have a surface lubrication to total lubrication ratio (SL ratio) of between about 5-20%.

4. The magnetic recording tape of claim 1, wherein the nano-particles comprise carbon black particles having a mean particle diameter of less than 80 nm.

5. The magnetic recording tape of claim 4, wherein the nano-particles comprise carbon black particles having a mean particle diameter of between about 5-50 nm.

6. The magnetic recording tape of claim 5, wherein the nano-particles comprise carbon black particles having a mean particle diameter of between about 10-20 nm.

7. The magnetic recording tape of claim 1, wherein the nano-particles comprise a surface area of between about 100-1000 m²/g.

8. The magnetic recording tape of claim 7, wherein the nano-particles comprise a surface area of between about 100-500 m²/g.

9. The magnetic recording tape of claim 1, wherein the magnetic recording layer comprises a remanent magnetization-thickness product (Mr*t) of between about 2.0 to 2.9 memu/cm².

10. A magnetic recording tape configured for increased surface lubricity, the magnetic recording tape comprising:
an elongated substrate; and
a magnetic side disposed on the substrate and including:
a magnetic recording layer defining an exposed magnetic recording surface opposite the substrate,
a support layer deposited on the substrate between the substrate and the magnetic recording layer, the support layer including carbon black particles having a surface area of between about 100-1000 m²/g and configured to release lubrication to the exposed magnetic recording surface.

11. The magnetic recording tape of claim 10, wherein the support layer configures the exposed magnetic recording surface to have a surface lubrication to total lubrication ratio (SL ratio) of between about 5-20%.

12. The magnetic recording tape of claim 10, wherein the support layer comprises a primary pigment and 20 parts carbon black particles by weight per 100 parts of the primary pigment.

13. The magnetic recording tape of claim 10, wherein the support layer comprises carbon black particles having a surface area of between about 100-500 m²/g and a lubricant selected from the group consisting of stearic acid, butyl stearate, isopropyl stearate, butyl oleate, butyl palmitate, butylmyristate, hexadecyl stearate, and oleyl oleate.

14. The magnetic recording tape of claim 10, wherein the support layer comprises carbon black particles having a particle size of between about 5-80 nm.

15. The magnetic recording tape of claim 10, wherein the magnetic recording layer comprises a remanent magnetization-thickness product (Mr*t) of between about 2.0 to 2.9 memu/cm².

16. A method of fabricating a magnetic recording tape providing improved surface lubrication, the method comprising:
providing a substrate having a first side and a second side opposite the first side;
coating a magnetic recording layer defining an exposed magnetic recording surface opposite the substrate; and
coating a support layer on the first side of the substrate that includes a lubricant and a dispersion of carbon black nano-particles having a surface topology that combine to configure the support layer to release lubrication to the exposed magnetic recording surface.

17. The method of claim 16, wherein the lubricant and the carbon black nano-particles combine to configure the support layer to have a surface lubrication to total lubrication ratio (SL ratio) of between about 5-20%.

18. The method of claim 16, wherein coating a support layer on the first side of the substrate comprises coating a support layer including a fluorinated lubricant and a dispersion of carbon black particles having a particle size of between about 5-80 nm.

19. The method of claim 16, wherein coating a support layer on the first side of the substrate comprises coating a support layer including a lubricant and a dispersion of carbon black particles having a surface area of between about 100-1000 m²/g.

20. The method of claim 16, wherein coating a magnetic recording layer comprises coating a magnetic recording layer opposite the substrate comprising a remanent magnetization-thickness product (Mr*t) of between about 2.0 to 2.9 memu/cm².
